(19) United States
(12) Patent Application Publication
(10) Pub. No.: US 2014/0146004 A1
(43) Pub. Date: May 29, 2014

(54) INPUT DEVICE

(71) Applicant: SAMSUNG ELECTRO-MECHANICS CO. LTD., Suwon (KR)

(72) Inventors: Jae Hyuk JANG, Suwon (KR); Dong Hyeok Choi, Suwon (KR); Jin Young Kim, Suwon (KR); Yong Il Kwon, Suwon (KR); No Il Park, Suwon (KR); Hak Kwan Kim, Suwon (KR)

(73) Assignee: Samsung Electro-Mechanics Co. Ltd., Suwon (KR)

(21) Appl. No.: 13/835,753

(22) Filed: Mar. 15, 2013

(30) Foreign Application Priority Data
Nov. 23, 2012 (KR) 10-2012-0133702

(51) Int. Cl. G06F 3/046

(52) U.S. Cl. CPC G06F 3/046
USPC 345/174

(57) ABSTRACT

There is provided an input device including a display panel having a first region for displaying an image, a touch panel attached to the display panel and detecting a touch input, and a digitizer module attached to the display panel and detecting an electromagnetic type digitizer input, wherein the digitizer module includes a plurality of circuit units formed in a second region corresponding to an edge of the first region, and at least a portion of the plurality of circuit units operates as a circuit unit for wireless communications.

### CROSS-REFERENCE TO RELATED APPLICATIONS

This application claims the priority of Korean Patent Application No. 10-2012-0133702 filed on Nov. 23, 2012, in the Korean Intellectual Property Office, the disclosure of which is incorporated herein by reference.

### BACKGROUND OF THE INVENTION

1. Field of the Invention

The present invention relates to a digitizer module provided in a lower portion of a display panel, and more particularly to an input device having a plurality of circuits for wireless communications in a region of a digitizer module corresponding to a bezel region of a display panel, to increase element integrity in a limited form factor, thereby facilitating a hardware design and concurrently reducing an overall thickness of an electronic device.

2. Description of the Related Art

As mobile electronic devices such as smartphones, tablet PCs and the like have become widely popular, research into technologies for implementing a variety of functions in a single small, lightweight device has been actively conducted. In particular, there are many cases in which electronic devices such as smartphones, tablet PCs, and the like include data input devices such as touchscreens, touch pads, and the like that can be manufactured to be ultra thin and may be integrated with other electronic device modules, for example, display modules, so as to provide a variety of data input methods while not degrading mobility when users carry electronic devices.

In general, capacitance type and resistive type touchscreens are applied to mobile electronic devices. Recently applicability of capacitive touchscreens capable of having excellent touch resolution in the case of a touch and being manufactured to have a reduced thickness have been increasingly manufactured. Capacitive touchscreens may be more advantageous than resistive touchscreens, but may be disadvantageously difficult to apply a pen input method, which is available in resistive touchscreens.

In particular, as smartphone screen sizes have grown and a variety of applications have been developed therefor, a case in which a user attempts various delicate data inputs on a smartphone screen or a tablet PC screen with a pen is increasing. In a case in which a digitizer module is additionally provided in a lower portion of a display device to overcome a disadvantage of a capacitive touchscreen, a variety of input methods using an additionally provided digitizer pen may be provided to the user. However, in a case in which smartphones and a tablet PCs have both a touchscreen and a digitizer module, problems in which an overall thickness is increased and a hardware design may be difficult to implement in terms of characteristics of a product having a limited form factor.

Patent Document 1 discloses an auxiliary coil provided on a substrate included in a digitizer module. The auxiliary coil is provided on the substrate different to a substrate on which a loop coil of the digitizer module is formed. Patent Document 2 discloses a circuit pattern for an RFID communication formed in a substrate included in a digitizer module and does not disclose an arrangement, structure and a shape of the circuit pattern. Meanwhile, Patent Document 3 discloses a shape of a general RFID antenna and does not disclose a digitizer module. Thus, none of cited references 1 through 3 disclose a structure in which the digitizer module and a circuit for wireless communications are integrally formed and the circuit for wireless communications is provided in a bezel region of a substrate of the digitizer module.

### RELATED ART DOCUMENT

(Patent Document 1) Japanese Patent Laid-Open Publication No. JP 2011-203918
(Patent Document 2) Korean Patent Laid-Open Publication No. KR 10-2009-0033659
(Patent Document 3) Korean Patent Laid-Open Publication No. KR 10-2011-0008478

### SUMMARY OF THE INVENTION

To solve the problem of the related art, an aspect of the present invention provides an input device including a digitizer module including at least one substrate in which a circuit pattern for wireless communications is formed in a region corresponding to a substrate edge. Therefore, an additional antenna substrate for wireless communications such as RFID, NFC, and the like is unnecessary, thereby lowering difficulty of a hardware design in a limited form factor and reducing an overall thickness.

According to an aspect of the present invention, there is provided an input device including: a display panel having a first region for displaying an image; a touch panel attached to the display panel and detecting a touch input; and a digitizer module attached to the display panel and detecting an electromagnetic type digitizer input, wherein the digitizer module includes a plurality of circuit units formed in a second region corresponding to an edge of the first region, and at least a portion of the plurality of circuit units operates as a circuit unit for wireless communications.

The touch panel may include an effective sensing region for detecting the touch and a bezel region provided in an edge of the effective sensing region, and the effective sensing region may correspond to the first region, and the bezel region may correspond to the second region.

The plurality of circuit units may include at least one of a near field communication (NFC) circuit, a radio frequency identification (RFID) circuit, and a circuit for detecting the electromagnetic type digitizer input.

The touch panel may be a capacitive touch panel.

The display panel may be stacked between the touch panel and the digitizer module.

The plurality of circuit units may have a stacked structure including a plurality of layers.

The digitizer module may include a soft magnetic sheet in which a plurality of loop coils for detecting the electromagnetic type digitizer input are provided.

According to another aspect of the present invention, there is provided an input device including: a display panel displaying an image; and a digitizer module formed on a lower surface of the display panel and detecting an electromagnetic type digitizer input, wherein the digitizer module includes at least one substrate including a soft magnetic sheet, a plurality of loop coils provided on the soft magnetic sheet and detecting the digitizer input, and a plurality of circuit units for wireless communications.

The plurality of circuit units may include at least one of a near field communication (NFC) circuit, a radio frequency identification (RFID) circuit, and a circuit for detecting the electromagnetic type digitizer input.

The input device may further include: a touch panel detecting a touch, wherein the touch panel is formed on an upper surface of the display panel.

The plurality of circuit units may be provided in an edge region of the substrate.

The plurality of circuit units may be provided on the substrate so as to have a stacked structure including a plurality of layers.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of an exterior of an electronic device to which an input device is applied according to an embodiment of the present invention;

FIG. 2 is a view for explaining a method of using an electronic device including an input device according to an embodiment of the present invention;

FIG. 3 is a view of a substrate provided in a digitizer module included in an input device according to an embodiment of the present invention;

FIG. 4 is a view of a stacked structure of an input device according to an embodiment of the present invention; and

FIGS. 5 through 7 are views respectively illustrating a structure of an input device according to an embodiment of the present invention in more detail.

### DETAILED DESCRIPTION OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

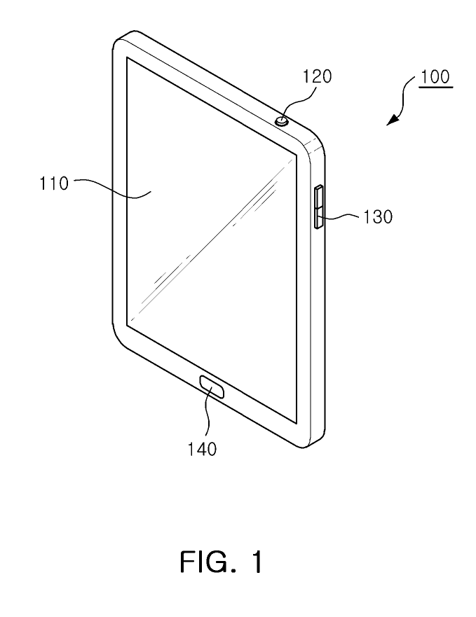

FIG. 1 is a perspective view of an exterior of an electronic device to which an input device is applied according to an embodiment of the present invention.

FIG. 1 is a diagram illustrating an electric device to which an input device is applicable according to an embodiment. Referring to FIG. 1, an electronic device 100 of the present embodiment includes a display device 110 and input units 120, 130, and 140. The electronic device 100 may be integrally formed with the display device 110 to provide a touchscreen device. The display device 110 may include an input device using a digitizer pen provided according to an embodiment of the present invention. A digitizer module that recognizes the digitizer pen may be integrally formed with the display device 110 in a similar manner to that of the touchscreen device.

In the touchscreen device provided integrally with the display device 110, the touchscreen device is generally provided on a front surface of the display device 110. Thus, the touchscreen device needs to have a high degree of light transmittance such that a screen displayed by the display device 110 can be transmitted therethrough. Thus, the touchscreen device can be implemented by forming a sensing electrode on a base substrate formed of a transparent film material such as polyethylene terephthalate (PET), polycarbonate (PC), polyethersulfone (PES), polyimide (PI) or the like and the sensing electrode is formed of an electrically conductive material such as indium-tin oxide (ITO), indium zinc oxide (IZO), zinc oxide (ZnO), carbon nanotubes (CNT), a conductive polymer, or graphene.

The digitizer module that recognizes an input of the digitizer pen may be disposed on a rear surface of the display device 110 according to an embodiment of the present invention. The display device 110 included in the electronic device 100 may generally be a flat panel display (FPD), for example, a liquid crystal display (LCD), an organic light emitting display (OLED), and the like. In a case in which the display device 110 is the LCD, the digitizer module may be disposed on a rear surface of a backlight unit (BLU) of the LCD, since a loop coil pattern included in the digitizer module may be formed of an opaque material.

The electronic device 100 of FIG. 1 may include at least one antenna substrate on which a circuit pattern for wireless communications is formed. In a case in which the antenna substrate for wireless communications is additionally provided inside the electronic device 100, the antenna substrate is added to a stacked structure of a display panel, a touchscreen, and the digitizer module, which increases an overall thickness and deteriorates the degree of freedom of design. Therefore, the present invention provides a structure of forming a substrate included in a digitizer module and an antenna substrate in which a circuit pattern for wireless communications is formed on a single substrate.

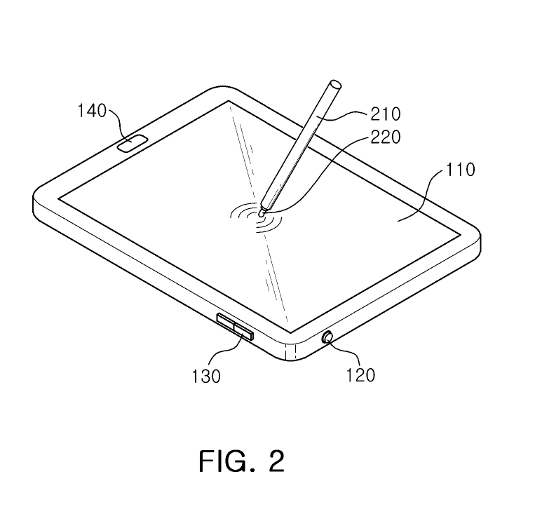

FIG. 2 is a view for explaining a method of using an electronic device including an input device according to an embodiment of the present invention.

The view of FIG. 2 shows a method of transferring a desired input to the display device 110 of the electronic device by using a digitizer pen by a user in a general manner. Referring to FIG. 2, a pen coil unit 220 included in the digitizer pen outputs a wireless signal while being disposed to be adjacent thereto. Thus, the digitizer module provided inside the electronic device senses the signal generated from the pen coil unit 220. In this case, an operation of the digitizer pen may be processed according to types of application being executed in the electronic device.

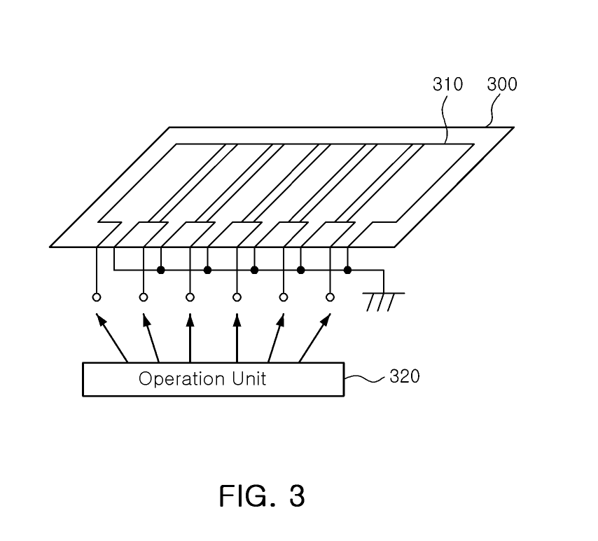

The digitizer pen may output a signal having a specific frequency band through the pen coil unit 220. To this end, a resonance circuit including a capacitor, an inductor and the like may be included in the digitizer pen. Frequency characteristics of the signal output from the pen coil unit 220 may be determined according to characteristics of the resonance circuit. A sensing circuit included in the digitizer module senses the signal output from the digitizer pen through a loop coil. This will be described with reference to FIG. 3.

FIG. 3 is a view of a substrate provided in a digitizer module included in an input device according to an embodiment of the present invention.

Referring to FIG. 3, a plurality of loop coil patterns 310 for sensing the signal output from the digitizer pen may be formed on a substrate 300. The loop coils 310 may be formed of an opaque metal material and have a closed loop shape on one surface of the substrate 300. One ends of the loop coils 310 forming a closed loop may be connected to a ground end, and other ends thereof may be connected to an operation unit 320 that calculate coordinates of the digitizer pen from a signal induced between the loop coils 310 and the digitizer pen.

As shown in FIG. 3, the loop coil patterns 310 provided on the substrate 300 may be formed in such a manner that adjacent loop coil patterns 310 have regions overlapped with each other. The plurality of loop coil patterns 310 are formed in such a manner that adjacent loop coil patterns 310 are overlapped with each other, which may block discontinuity of a signal generated between one specific loop coil pattern 310 and the other loop coil pattern 310 adjacent thereto when the digitizer pen moves, thereby more accurately detecting a location of the digitizer pen. In comparison with a case in which the loop coil patterns 310 are formed not to overlapped with each other, an error in coordinate detection that occurs because an intensity of the signal output from the digitizer pen may not sufficiently detected between the loop coil patterns 310 may be prevented, thereby increasing a resolution of the coordinate detection.

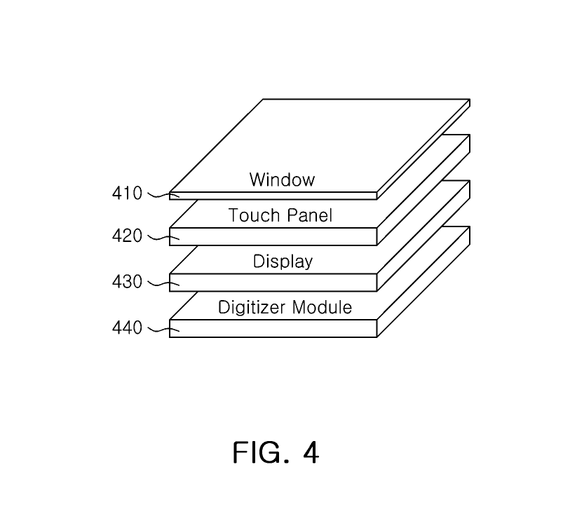

FIG. 4 is a view of a stacked structure of an input device according to an embodiment of the present invention.

Referring to FIG. 4, the input device according to the present embodiment may include a window substrate 410 for directly accommodating a user's touch, a touch panel 420 disposed between the window substrate 410 and a display panel 430, a display panel 430 for outputting a screen, and a digitizer module 440. The touch panel 420 may be a resistive type or a capacitance type, and have high light transmittance in such a way that an image output by the display panel 430 can be transmitted.

The display panel 430 may be a flat panel display (FPD) apparatus, for example, a liquid crystal display (LCD), an organic light emitting display (OLED), and the like. The digitizer module 440 may be disposed on a lower portion of the display panel 430. The digitizer module 440 may include an opaque substrate and a loop coil pattern, and thus the digitizer module 440 may be disposed on a rear surface of a backlight unit (BLU) of the display panel 430.

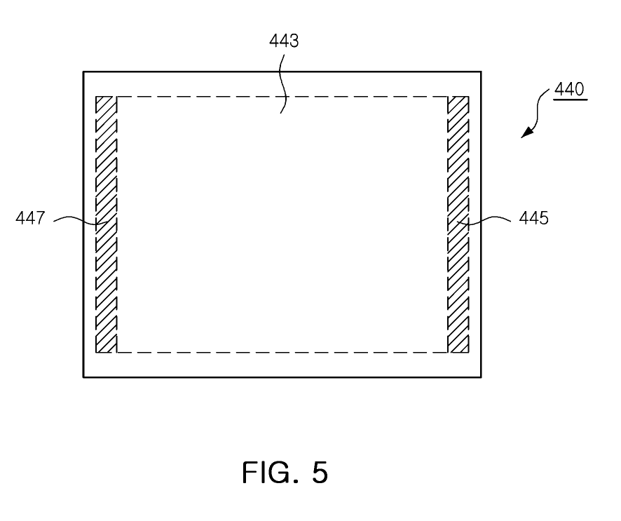

Although it is assumed that the loop coil patterns are formed on the single substrate 300 to explain an operational principle of the digitizer module 440 in FIG. 3, a plurality of the substrates 300 may be provided so as to sense all the locations in X- and Y-axial directions on a plane. In this regard, the plurality of loop coil patterns 310 may be respectively formed on the plurality of substrates 300 included in the digitizer module 440. In the embodiment of the present invention, a plurality of circuit patterns for wireless communications are provided on edge regions of the substrate 300 in which the plurality of loop coil patterns 310 are not formed. This will be described with reference to FIGS. 5 through 7.

FIGS. 5 through 7 are views respectively illustrating a structure of an input device according to an embodiment of the present invention in more detail.

FIG. 5 is a plan view of the digitizer module 440 included in the input device according to an embodiment of the present invention. The digitizer module 440 may include a first region 443 in which the loop coil patterns 310 are formed and second regions 445 and 447 in which a plurality of circuit patterns are provided. In this regard, structurally, the first region 443 may correspond to a screen display region of the display panel 430, and the second regions 445 and 447 may correspond to bezel regions. Unlike FIG. 5, the second regions 445 and 447 may be provided in window shapes entirely surrounding the first region 443.

The circuit patterns provided in the second regions 445 and 447 may have a structure of the digitizer module 440 and a monolayer or multilayer structure according to the number of necessary wireless communications modules. The loop coil patterns 310 may be formed in the first region 443 of the digitizer module 440. Wire circuits connecting the loop coil patterns 310 and the operation unit 320 may be disposed in the second region 445. Thus, in a case in which the wire circuits connecting the loop coil patterns 310 and the operation unit 320 and the circuit patterns for wireless communications are concurrently formed, circuits of a multilayer structure may be formed in the second regions 445 and 447.

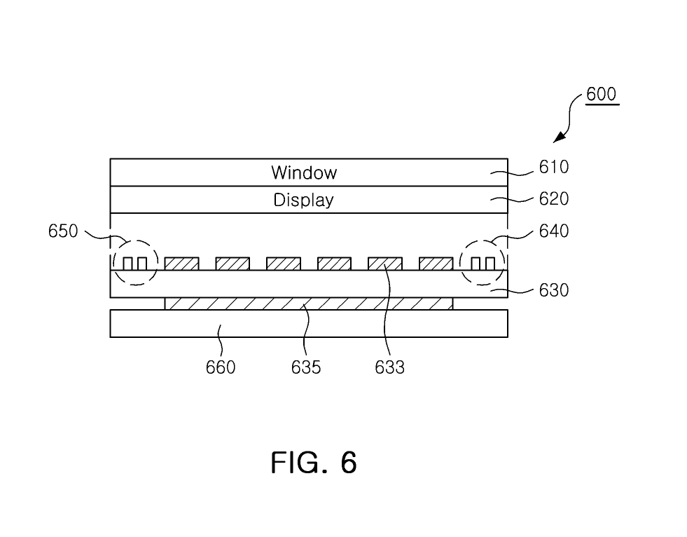

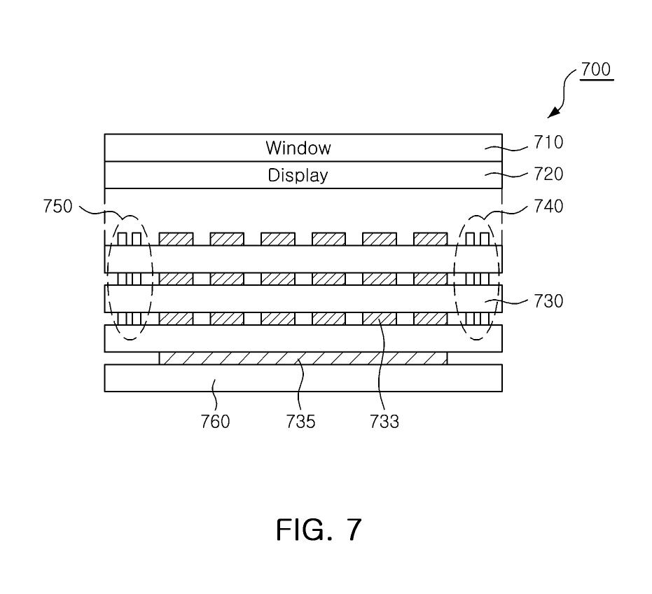

FIGS. 6 and 7 are detailed views of a stacked structure of the input device according to an embodiment of the present invention. Although display panels 620 and 720 are directly disposed on lower portions of the window substrates 610 and 710 in FIGS. 6 and 7, a touch panel may be additionally disposed between the window substrates 610 and 710 and the display panels 620 and 720.

FIG. 6 is a view of an input device 600 including a digitizer module having a monolayer structure. The digitizer module is provided in lower portions of the window substrate 610 and the display panel 620, and senses a location of the digitizer pen through a plurality of loop coil patterns 633 and 635 provided on upper and lower surfaces of an insulation layer 630. A soft magnetic sheet 660 is provided in a lower portion of the insulation layer 630. At least one of a near field communication (NFC) circuit, a radio frequency identification (RFID) circuit, and a circuit for detecting an electromagnetic type digitizer input may be provided in edge regions 640 and 650 of the insulation layer 630 in which the loop coil patterns 633 and 635 are not formed. In this regard, the circuit detecting the digitizer input may be a wire circuit connecting the loop coil patterns 633 and 635 and an operation circuit.

In terms of manufacturing processing, the digitizer module may be manufactured by printing a metal wire on the soft magnetic sheet 660 by using coil compression, sputtering, silk screening, tape casting, and the like, adhering the insulation layer 630 on the metal wire, drying the insulation layer 630, and additionally forming a necessary metal wire layer and polymer layer. That is, the loop coil patterns 633 and 635 for sensing the location of the digitizer pen and the circuit for wireless communications may be integrally formed with the soft magnetic sheet 660, thereby reducing a thickness of the input device 600.

FIG. 7 is a cross-sectional view of a digitizer module having a multilayer structure. Likewise in FIG. 6, the digitizer module may be provided in the lower portions of the window substrate 710 and the display panel 720, and include a soft magnetic sheet 760, a plurality of loop coil patterns 733 and 735, and a plurality of insulation layers 730. However, unlike FIG. 6, the digitizer module includes the plurality of insulation layers 730. Circuit patterns for wireless communications are provided in edge regions 740 and 750 of the plurality of insulation layers 730.

In the multilayer structure of FIG. 7, the circuit patterns for wireless communications and the loop coil patterns for detecting a location of a digitizer pen are integrally formed, thereby obtaining an effect of reducing an overall thickness. Although the circuit patterns for wireless communications are generally disposed on a rear surface of an electronic device, the circuit patterns may be implemented on a front surface thereof according to the present invention.

As set forth above, according to the embodiments of the invention, circuit patterns for wireless communications such as RFID, NFC, and the like are formed in edge regions of a substrate in which loop coils for recognizing a signal output from a digitizer pen are not formed while the loop coils are formed on the substrate. Therefore, the digitizer module and an antenna module necessary for communications may be manufactured as a single component, thereby reducing an overall thickness thereof and increasing space availability in a limited form factor.

While the present invention has been shown and described in connection with the embodiments, it will be apparent to those skilled in the art that modifications and variations can be made without departing from the spirit and scope of the invention as defined by the appended claims.

What is claimed is:

1. An input device comprising:
a display panel having a first region for displaying an image;
a touch panel attached to the display panel and detecting a touch input; and
a digitizer module attached to the display panel and detecting an electromagnetic type digitizer input,
wherein the digitizer module includes a plurality of circuit units formed in a second region corresponding to an edge of the first region, and
at least a portion of the plurality of circuit units operates as a circuit unit for wireless communications.

2. The input device of claim 1, wherein the touch panel includes an effective sensing region for detecting the touch and a bezel region provided in an edge of the effective sensing region, and
the effective sensing region corresponds to the first region, and the bezel region corresponds to the second region.

3. The input device of claim 1, wherein the plurality of circuit units include at least one of a near field communication (NFC) circuit, a radio frequency identification (RFID) circuit, and a circuit for detecting the electromagnetic type digitizer input.

4. The input device of claim 1, wherein the touch panel is a capacitive touch panel.

5. The input device of claim 1, wherein the display panel is stacked between the touch panel and the digitizer module.

6. The input device of claim 1, wherein the plurality of circuit units have a stacked structure including a plurality of layers.

7. The input device of claim 1, wherein the digitizer module includes a soft magnetic sheet in which a plurality of loop coils for detecting the electromagnetic type digitizer input are provided.

8. An input device comprising:
a display panel displaying an image; and
a digitizer module formed on a lower surface of the display panel and detecting an electromagnetic type digitizer input,
wherein the digitizer module includes at least one substrate including a soft magnetic sheet and a plurality of loop coils provided on the soft magnetic sheet and detecting the digitizer input, and
the substrate comprises a plurality of circuit units for wireless communications.

9. The input device of claim 8, wherein the plurality of circuit units include at least one of a near field communication (NFC) circuit, a radio frequency identification (RFID) circuit, and a circuit for detecting the electromagnetic type digitizer input.

10. The input device of claim 8, further comprising a touch panel detecting a touch input,
wherein the touch panel is formed on an upper surface of the display panel.

11. The input device of claim 8, wherein the plurality of circuit units are provided in an edge region of the substrate.

12. The input device of claim 8, wherein the plurality of circuit units are provided on the substrate so as to have a stacked structure including a plurality of layers.
